(19) United States
(12) Patent Application Publication
(10) Pub. No.: US 2012/0110817 A1
(43) Pub. Date: May 10, 2012

(54) Portable Outdoor Cooking Device

(76) Inventor: Brian Lee Begotka, Suamico, WI (US)

(21) Appl. No.: 13/008,620

(22) Filed: Jan. 18, 2011

Related U.S. Application Data
(63) Continuation of application No. 12/041,209, filed on Mar. 3, 2008, now abandoned.
(60) Provisional application No. 60/892,898, filed on Mar. 5, 2007.

(51) Int. Cl. B23P 19/04

(52) U.S. Cl. 29/428

(57) ABSTRACT

A portable outdoor cooking device assembly can include a structural support member, the structural support member including a plurality of components that are coupled together to form the structural support member. The example assembly can include an anchoring pin coupled to the structural support, and a cooking surface assembly, and a vertical adjustment mechanism coupled to the structural support member and the cooking surface assembly, the vertical adjustment mechanism allowing the spatial position of the cooking surface assembly to be vertically modified. The example assembly also includes a heat plate includes a concave space into which at least a portion of the cooking surface assembly is positioned, a motor coupled to the cooking surface assembly to spin the cooking surface assembly, and a power source connected to the motor to supply power to the motor.

### RELATED APPLICATION

This application claims the benefit of U.S. Patent Provisional Application Ser. No. 60/892,898 filed on Mar. 5, 2007, the entirety of which is hereby incorporated by reference.

### BACKGROUND

Portable outdoor cooking devices typically include a cooking surface, such as a grill grating, supported by a complementary structure that stabilizes the cooking surface element positioned over a campfire or fire pit. Such outdoor cooking devices can be used to cook food in a wide variety of settings, such as public outdoor recreation facilities or on camping or hunting trips.

One concern with current outdoor cooking devices is that it is difficult to provide a portable rotary grill with safe and flexible three dimensional displacement of the cooking surface. Typically, features for spatial adjustment of the cooking surface require tools or the application of force to non-ergonomic thumb screws and the like. Further, proximity of the spatial adjustment features to the open flame during use can make safe access difficult. In addition, hot spots associated with the heat source can result in food that is cooked unevenly. Accordingly, it is desirable to incorporate portability, safety and ergonomic efficiency into an outdoor cooking device.

### SUMMARY

Example embodiments described herein generally relate to portable cooking devices.

### DESCRIPTION OF THE DRAWINGS

Aspects of the disclosure may be more completely understood in consideration of the following detailed description of various embodiments of the disclosure in connection with the accompanying drawings, in which:

FIG. 1 is a side view of an example assembled portable cooking grill.

FIG. 2 is an end view of the example assembled portable cooking grill of FIG. 1.

FIG. 3 is a side view of an example heat plate.

FIG. 4 is a side view of an example grill grating

FIG. 5 is a perspective view of the example grill grating of FIG. 4.

FIG. 6 is a schematic of an example rotary unit housing.

FIG. 7 is an internal schematic view of an example compartmentalized carrying case.

FIG. 8 is a side view of an example grill grating and an example heat plate fitted together for storage.

FIG. 9 is an external schematic bottom view of an example compartmentalized carrying case.

FIG. 10 is a side view of the example carrying case of FIG. 9.

FIG. 11 is a front view of the example carrying case of FIG. 9.

FIG. 12 is perspective view of the example carrying case of FIG. 9.

FIG. 13 is a flowchart showing an example method for assembly of a portable cooking device.

FIG. 14 is an exploded perspective view of an alternate example embodiment of a portable cooking grill.

FIG. 15 is a side view of an example structural support member including a plurality of accessory hooks.

FIG. 16 is a side view of one of the example accessory hooks of FIG. 15.

FIG. 17 is a side view of an alternative embodiment of another example cooking assembly including a warming grate.

FIG. 18 is a top view of the cooking assembly of FIG. 17.

FIG. 19 is a top view of an alternative embodiment of an example cooking surface that is hinged.

FIG. 20 is a side view of the cooking surface of FIG. 19 incorporated into a cooking assembly.

### DETAILED DESCRIPTION

The present disclosure relates generally to portable cooking devices. More particularly, the disclosure relates versatile, spatially adjustable, rotary portable grills useable in different soil conditions. While the present disclosure is not so limited, an appreciation of the various aspects of the disclosure will be gained through a discussion of the examples provided below.

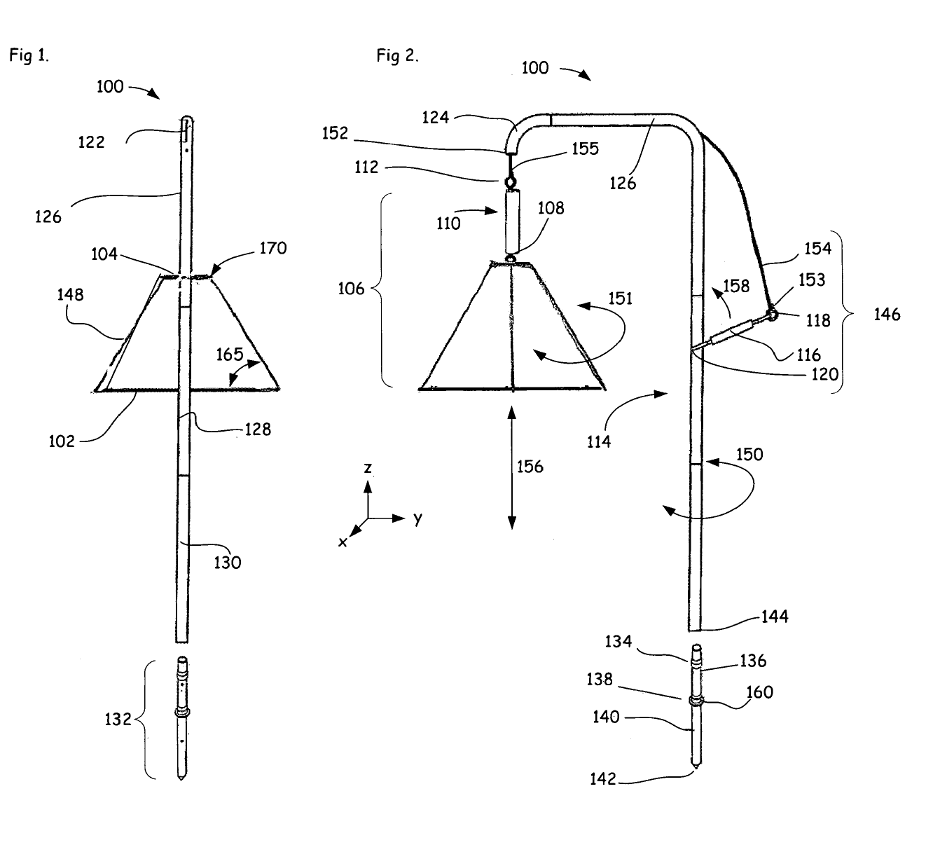

Referring now to FIGS. 1-3, an example embodiment of an adjustable, rotary portable grill 100 is shown. In the example shown, the portable grill 100 is assembled piecewise from elements conveniently stored in a compartmentalized carrying case 300, which is described further below. Once the portable grill 100 is assembled, it can be securely staked into ground of various different geological compositions utilizing a modular anchoring pin 132.

In the example shown, the portable grill 100 includes a generally J-shaped or hook-shaped support structure 114 including several support structure members, including a first sectional pipe 124, a second sectional pipe 126, a third sectional pipe 128 and a fourth sectional pipe 130. In the example shown, each of the pipes 124, 126, 128, 130 is generally cylindrical in shape, having a generally round, oval, or rectangular cross-section, although other designs are possible.

A cooking surface assembly 106 including a cooking surface 102 can be positioned over a campfire or fire pit by swiveling the structural support member 114 in directions 150 for up to and including 360 degrees of rotation in one or both of counterclockwise and clockwise directions. In example embodiments a vertical adjustment assembly 146 can be used for vertical displacement in directions 156. The cooking surface assembly 106 can demonstrate variable speed rotisserie features in directions 151 via a rotary unit housing 110. Other configurations for the portable grill are possible. For example, the cooking surface assembly 106 can be modified to perform functionally as a portable oven.

The support structure members are positioned together to form the support structure 114 via a slip/sleeve fitting mechanism. The slip/sleeve fitting is a male/female coupling mechanism where each respective sectional pipe member has on one end of the pipe configured to receive a complementary feature on an adjacent support structure member.

The support structure 114 slip/sleeve fitting mechanism dually provides for maintaining the structural integrity of the portable grill 100 while allowing for assembly/disassembly. Alternative designs for the support structure members are possible. For example, each of the respective support sectional pipe members, such as first and second sectional pipes 124, 126, can be fabricated to include the ability to telescope, allowing for flexibility regarding length extension or reduction, as described in further detail below.

The collective support structure members can be fabricated from a variety of durable, lightweight piping materials, such as aluminum, carbon steel, or stainless steel. Other materials, such as a heat-resistant polymer, can be used.

In the embodiment, the assembly of the portable grill 100 initially includes insertion of an anchoring pin 132 into the fourth sectional pipe 130 of the support structure 114. As described below, the anchoring pin 132 is configured to facilitate the stability of the portable grill 100 at selected implant sites that may have different ground soil conditions.

The support structure 114 can be assembled as follows. Upon initial insertion of the anchoring pin 132 into the fourth sectional pipe 130 forward motion proceeds until a leading edge 144 engages with a flange member 138, a movable ring that axially engages the anchoring pin 132 exploiting a pressure fitting. The flange member 138 can be positioned anywhere between a first depth indicator 136, designating use of the portable grill 100 in clay-like soil conditions, and a second indicator 140 for loose soil conditions. Other configurations for the flange member 138 are possible. For example, a flange lip member 160 may employ various geometric configurations to further facilitate the stabilization of the portable grill 100 in a wide range of soil conditions.

Upon complete insertion of the anchoring pin 132 into the fourth sectional pipe 130 of an assembled support structure 114 a circumferential contact is established between the leading edge 144 and the flange member 138, thereby functioning as swivel point for rotation of the cooking surface assembly 106 in an x-y plane 150. Additionally, a radial contact between a frictional member 134 and an inner diameter (not shown) of the fourth sectional pipe 130 provides moderate resistance for controllable swivel action. Further, a beveled tip 142 is provided to facilitate anchoring pin 132 setting.

As indicated, the support structure 114 coupled with an anchoring pin 132 inserted in the ground provides swivel point for the backbone of the portable grill 100, allowing for 360 degrees of rotation of the cooking surface assembly 106 in an x-y plane in the directions 150. As described further below, this movement allows for positioning the cooking surface assembly 106 over a campfire or fire pit.

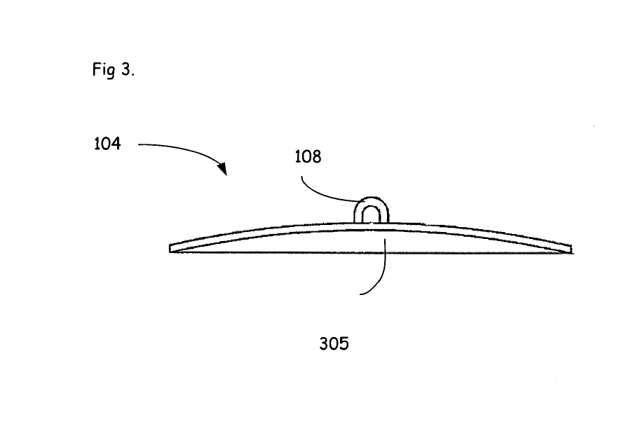

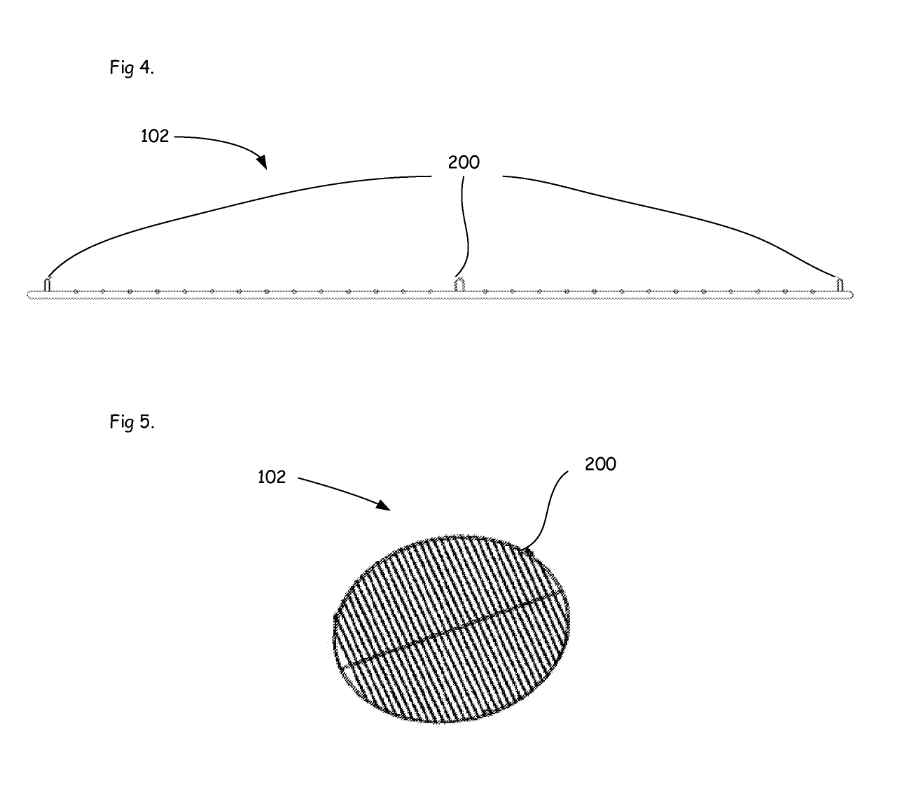

Referring to FIG. 3, the heat plate 104 includes a welded eye hook 108, and is shaped with a general upside down concavity 305. In the embodiment, the heat plate 104 serves to protect the rotary unit housing 110 from exposure to direct heat, thereby prolonging its lifetime. Additionally, the heat plate concavity 305 efficiently facilitates water run-off directed away from the cooking surface 102. The heat plate 104 can be fabricated from a variety of durable, lightweight heat resistant materials including aluminum, carbon steel, or stainless steel. Other configurations for the heat plate 305 are possible. For example, the heat plate can be incorporated into a modified cooking surface assembly 106 to perform functionally as a portable oven.

Referring now to FIGS. 4 and 5, the cooking surface assembly 106 includes the cooking surface 102, a plurality of grating cables 148, a heat plate 104 and rotary unit housing 110. The cooking surface 102 can be a grill grating supported by the grating cables 148, where each respective grating cable is connected to a complementary eye hook 200 situated along the periphery of the cooking surface 102. The grating cables 148 are in turn connected to apertures (not shown) of functional size and shape situated along a periphery 170 of the heat plate 104. In the example embodiment, the heat plate apertures are situated on the periphery 170 of heat plate 104 to facilitate easy access to food placed on the cooking surface 102 by maximizing an angle 165 between a respective grating cable 148 and the cooking surface 102, as shown in FIG. 1.

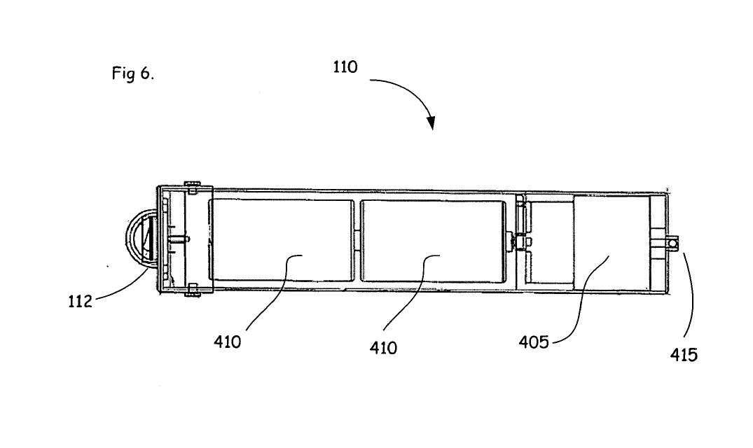

Referring to FIG. 6, the cooking surface assembly 106 can include a rotary unit housing 110 provided to prevent weathering and heat damage of a variable speed rotisserie mechanism. The example rotary unit housing 106 can include a DC motor 405, a battery compartment 410, a drive shaft 415 and an on/off switch (not shown) enclosed in a weather proof compartment. In example embodiments, the battery compartment 410 holds one or more batteries, such as two D size batteries. The batteries are used to power the DC motor 405. The DC motor 405 turns the drive shaft 415 which, in turn, rotates the cooking surface assembly 106 in clockwise/counterclockwise directions 151. Alternative designs can include other components as well, such as incorporating electronics for wireless control of the variable speed rotisserie. In yet other alternatives, the motor 405 can be powered by an external power source, such as a portable generator.

Referring again to FIGS. 1 and 2, in the embodiment shown, the assembly of the portable grill 100 includes the attachment of the vertical adjustment assembly 146 to the cooking surface assembly 106, both of which are supported by the support structure 114, thereby allowing for three-dimensional positioning of the cooking surface assembly 106 relative to a fire.

A first end 153 of a cable 154 is attached to a first eye hook 118 affixed to a handle 116 that is coupled to the support structure 114 with a movable, coaxially disposed adjustment collar 120. A second end 155 of the cable 154 is initially threaded through a slotted line aperture 122 in the second sectional pipe 126 and then through an end opening 152 of the first sectional pipe 124.

Once the respective cable ends are positioned correctly, the adjustment collar 120 is generally positioned in an upright parallel position 158 relative to the support structure 114, thereby fully displacing the available cable length through the end opening 152 of the first sectional pipe 124. Subsequently, the sum length from first end 153 to the second end 155 of the cable 154 plus the length of the cooking surface assembly 106 can be used to determine the vertical positioning of the cooking surface assembly 106 relative to the fire.

Once a desired vertical displacement is determined the cooking surface assembly 106 can be coupled to the second end 155 of the cable 154 via fastening to a second eye hook 112 welded to the rotary unit housing 110. Tension on the cable from force developed by the weight of the cooking surface assembly 106 provides a secure lever arm locking mechanism with the adjustment collar 120 functioning as the fulcrum. With the vertical displacement of the cooking surface assembly 106 determined, the support structure 114 can be pivoted in the direction 150 to position the cooking surface assembly 106 over a heat source such as a fire or electric grill.

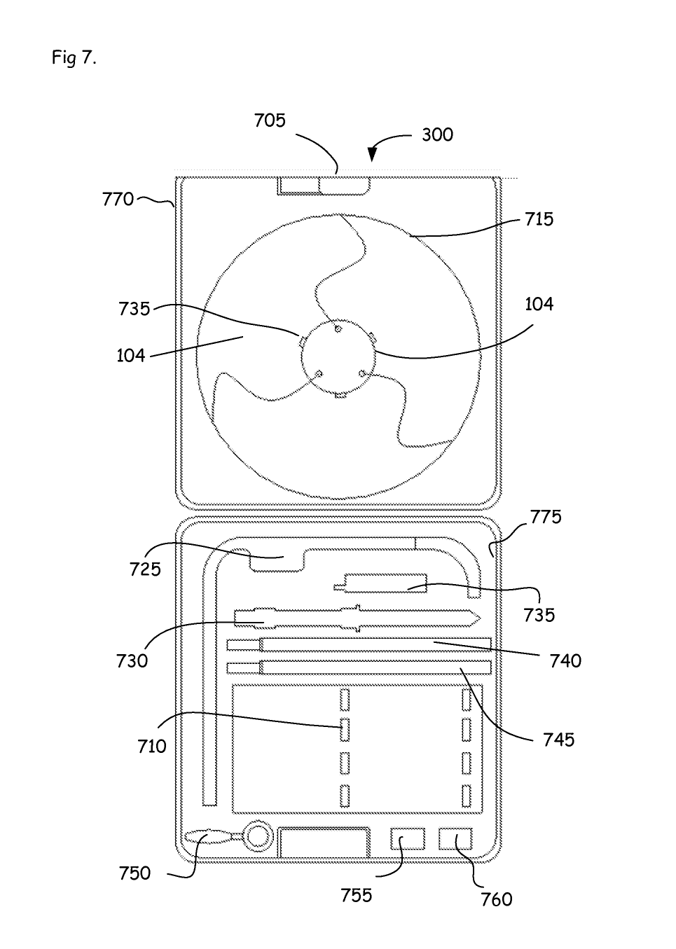

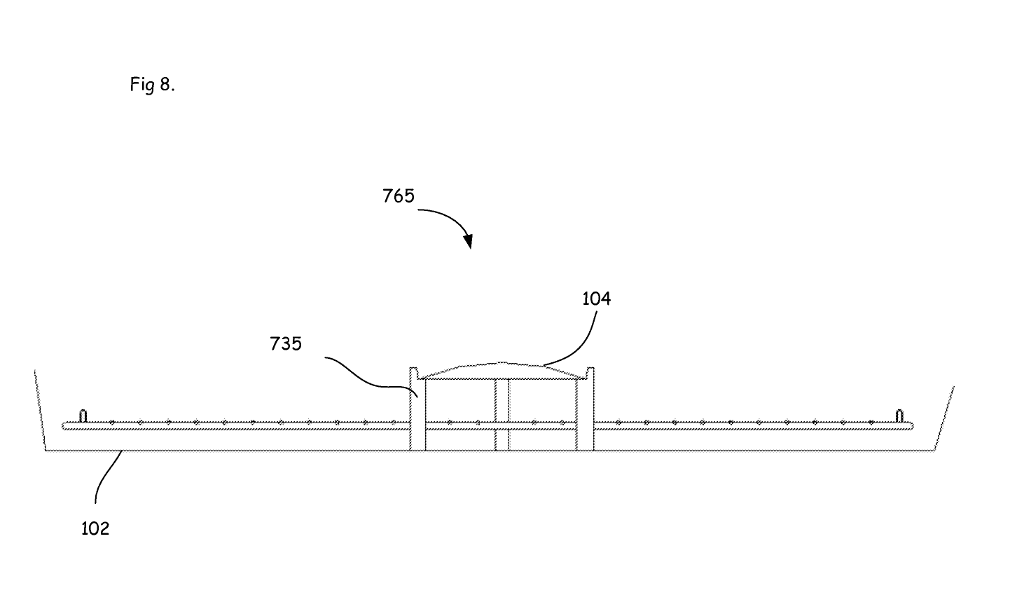

Referring now to FIGS. 7-9, in the example shown, the portable grill 100 can be disassembled so that all elements can be contained in a carrying case 300. The carrying case 300 can be made from lightweight resilient materials, such as molded thermoplastic elastomer (TPE), and includes external and internal features to facilitate handling and storage of the portable grill 100. Additionally, the carrying case 300 includes a plurality of plastic support feet 900 to allow the carrying case 300 to stand upright on a surface.

In the embodiment shown, the compact carrying case 300 includes a plurality of fitted storage sections or spaces for one or more of the various components of the portable grill 100. In the embodiment shown, the compact carrying case 300 includes first and second sectional pipe storage spaces 725, third sectional pipe storage space 740, fourth sectional pipe storage space 745, and anchoring pin storage space 730. Additionally, sections are provided for rotary unit housing storage space 735, handle storage space 750, general storage space 710 for the cable 345 and peripheral materials, and two “D” battery storage spaces 755 and 760.

For convenience, a unit assembly 765 including the cooking surface 102, grating cables 148 and heat plate 104 can be conveniently fitted together and stored in compartment storage space 715. Additional a plurality of prong members 735 may be made available to secure the unit assembly in place. The prong members 735 may be incorporated into the cooking surface 102 or manufactured as part of the carrying case 300.

The internal compartmentalized storage may be constructed from a soft foam-like material or a hard plastic material utilizing a snap-in mechanism to secure the respective elements or a combination thereof.

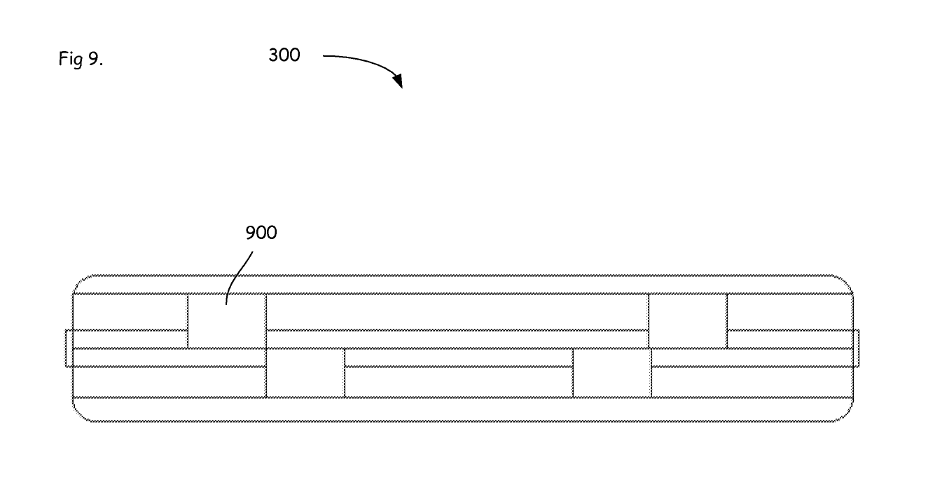

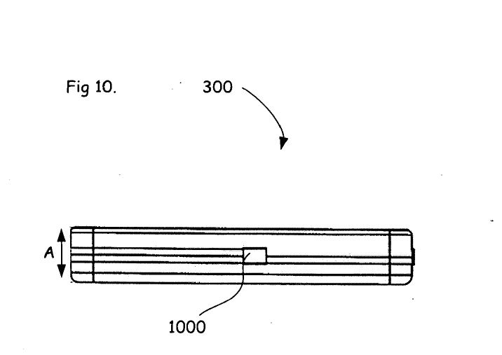

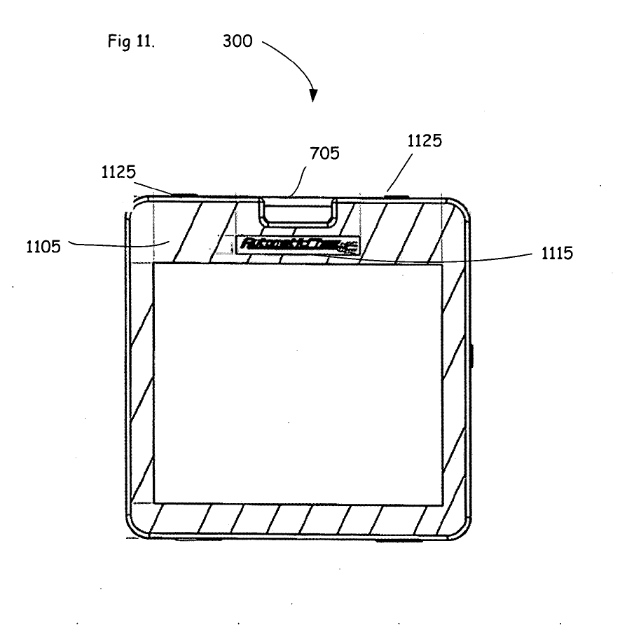

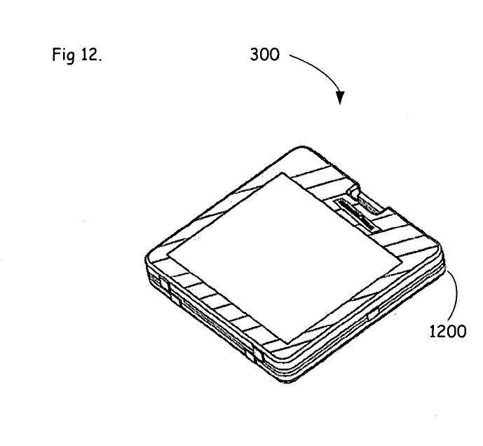

Referring to FIGS. 9-12, the compact carrying case 300 includes external features to facilitate handling and storage including a case handle 705, a plurality of support feet 900, a rugged peripheral surface 1105 to prevent sliding and the like, rounded corners 1200 to reduce wear and prevent injury, and a thin profile A, for convenient permanent storage or storage in a vehicle. Provision is also made for a vendor specific labeling surface 1115.

There are many possible options regarding a closing and release mechanism for the carrying case 300, including but not limited to, a snap shut mechanism whereupon closing a carrying case lid 770 to a carrying case base 775 connected by a plurality of hinge members (not shown) would engage a plurality of clip retainment members 1125. In the embodiment, a pressure release mechanism 1000 disengaging the clip retainment members 1125 could be employed.

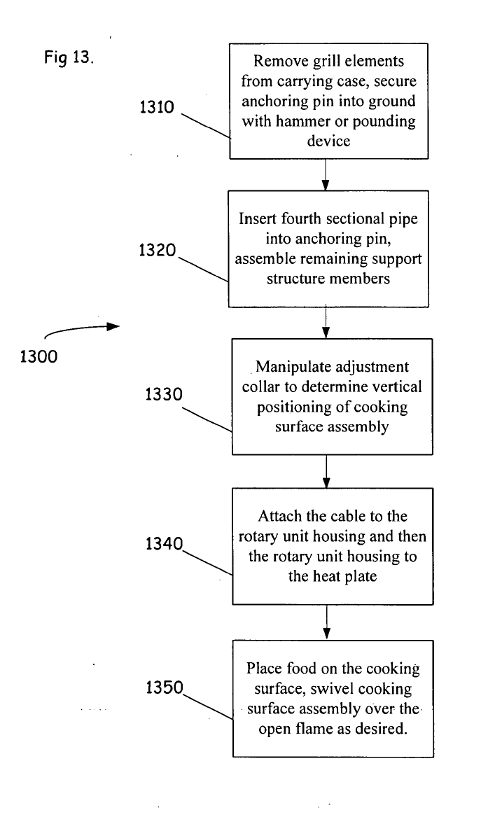

Referring now to FIG. 13, an example method 1300 is shown to assemble the portable grill and position the cooking surface assembly over an open flame. Initially, at operation 1310, the user removes the portable grill elements from the compartmentalized carrying case and secures the anchoring pin into the ground with a hammer or pounding device. Next, at operation 1320, the user inserts the fourth sectional pipe of the support structure into the anchoring pin and proceeds to assemble the remaining support structure members. Next, at operation 1330, the user manipulates the adjustment collar to determine the vertical positioning of the cooking surface assembly relative to the fire. Next, at operation 1340, the user attaches the cable to the rotary unit housing and then attaches the rotary unit housing to the heat plate of the cooking surface assembly. Next, at operation 1350, the user places food on the cooking surface, wherein the cooking surface assembly can be swiveled over the open flame as desired.

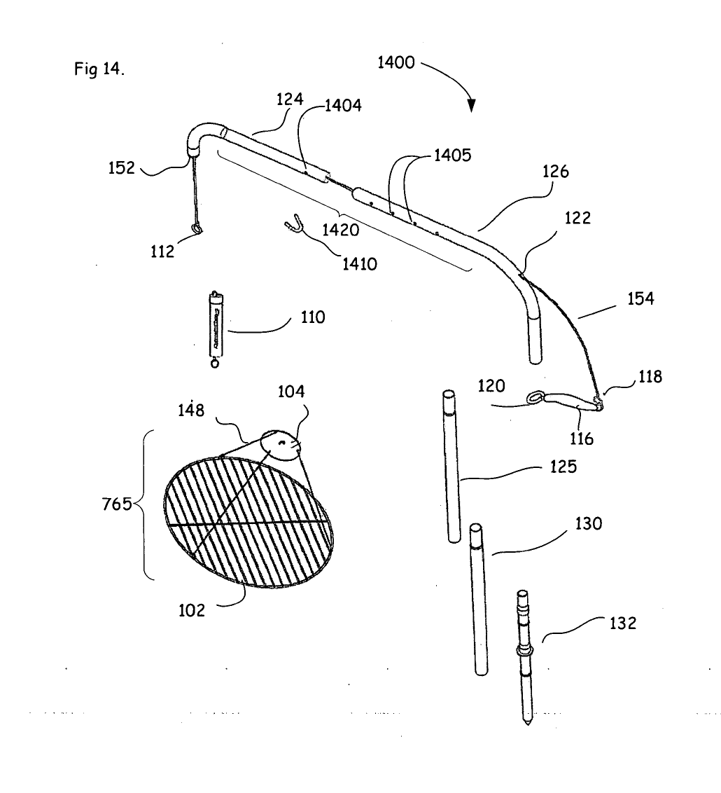

Alternative example embodiments of the portable grill 100 are possible. For example, an alternative embodiment of a grill 1400 is shown in FIGS. 14. The grill 1400 is similar to that of the grill 100, except that the grill 1400 includes telescoping features, as described below.

A first telescope aperture 1404 disposed along a longitudinal axis of the first sectional pipe 124 and a plurality of secondary telescope apertures 1405 disposed along a longitudinal axis of the second sectional pipe 126 allow for flexibility regarding an arm length 1420 extension or reduction. A desired arm length 1420 is established by securing the first sectional pipe 124 with respect to the second sectional pipe 126. This is achieved by moving the first sectional pipe 124 relative to the second sectional pipe 126 until the first telescope aperture 1404 of the first sectional pipe 124 is positioned at the desired one of the secondary telescope apertures 1405. Then, a rigid “U-shaped” telescope clip 1410 can be inserted through the telescope apertures 1404, 1405 to secure the first sectional pipe 124 to the second sectional pipe 126 at the desired relative length.

Additionally, in the alternative embodiment of the grill 1400, assembly of the portable grill 100 and storage of the portable grill 100 in the carrying case 300 can be simplified by maintaining that the cable 154 (with elements handle 125, adjustment collar 120, first eye hook 118, second eye hook 112 and rotary unit housing 110 permanently coupled to the cable 154) is threaded at all times through the first sectional pipe end opening 152 and second sectional pipe slotted line aperture 122, respectively.

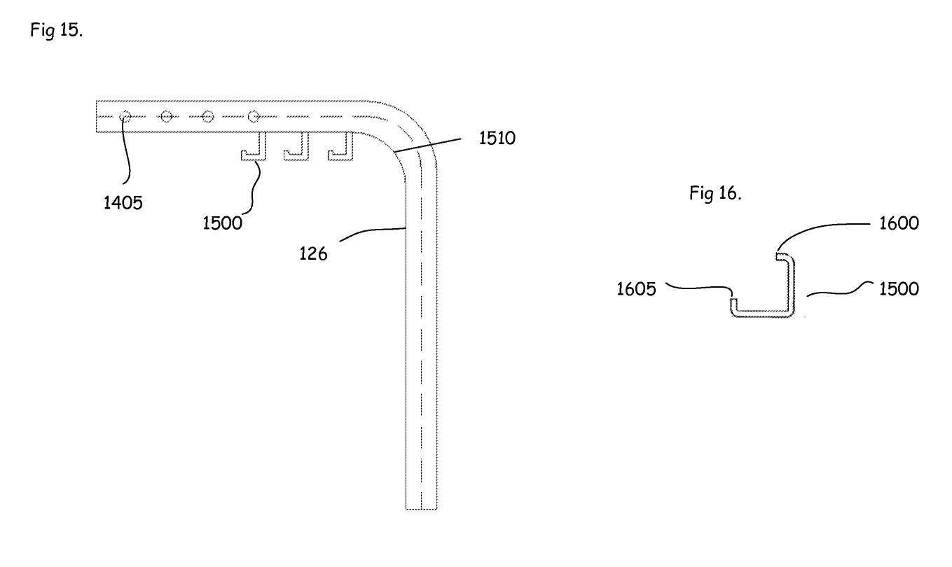

Referring now to FIGS. 15 and 16, in another alternative embodiment, a plurality of accessory hooks 1500 can be inserted into a plurality of hook apertures (not shown) disposed along a longitudinal axis of the second sectional pipe 126 near a ninety degree bend 1510. Each accessory hook 1500 is generally “C-shaped,” with a first hook member 1600 and a second hook member 1605. The first hook member 1600 is utilized to secure the accessory hook 1500 to the second sectional pipe 126 upon insertion of the accessory hook 1500 into a respective hook aperture. The second hook member 1605 is used to actively secure various accessories hanging or engaged with the accessory hook 1500, such as pots, pans, and cooking utensils like spatulas, etc.

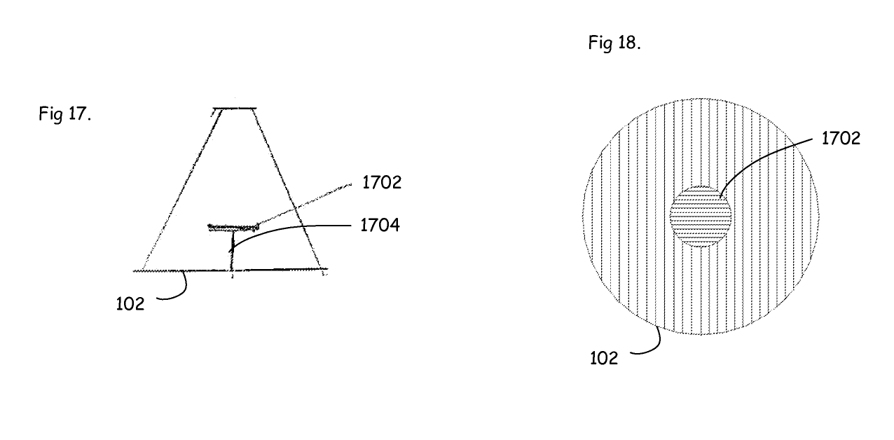

Referring now to FIGS. 17 and 18, in another alternative embodiment, a center warming grate 1702 is positioned above the cooking surface 102. The warming grate 1702 can be used to cook and keep food warm. The warming grate 1702 can be smaller in diameter than the cooking surface 102. In one embodiment, the warming grate 1702 is approximately 6 to 8 inches in diameter. In the example shown, the warming grate 1702 is suspended above the cooking surface 102 by a member 1704. The member 1704 can be sized to suspend the warming grate 1702 at approximately 4 to 5 inches above the cooking surface 102. In some embodiments, the warming grate 1702 and the member 1704 are configured to fold down flat against the cooking surface 102 for storage. Other configurations are possible.

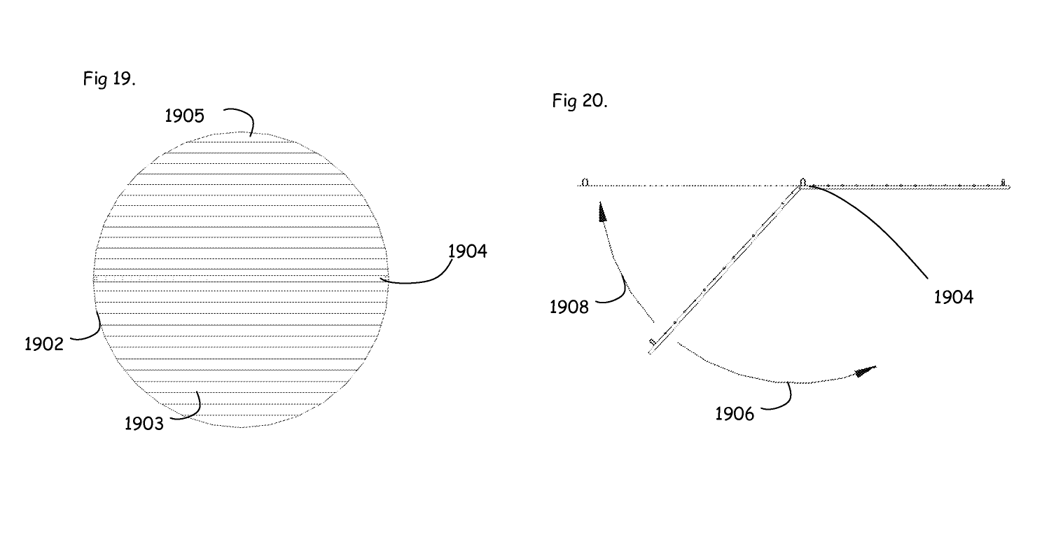

Referring now to FIGS. 19 and 20, another embodiment of a cooking surface 1902 includes a hinge member 1904. The hinge member 1904 allows a first portion 1903 of the cooking surface 1902 to be folded in directions 1906, 1908 upon a second portion 1905 of the cooking surface 1902. Folding the cooking surface 1902 in this manner allows the cooking surface 1902 to take up approximately one-half of the amount of space during storage. For example, the cooking surface 1902 can be folded in the direction 1906 before placement in the carrying case so that the carrying case can have smaller dimensions. When the cooking surface 1902 is removed from the carrying case, the cooking surface 1902 can be unfolded in the direction 1904 to provide a larger cooking area. Other configurations are possible.

The preceding embodiments are intended to illustrate without limitation the utility and scope of the present disclosure. Those skilled in the art will readily recognize various modifications and changes that may be made to the embodiments described above without departing from the true spirit and scope of the disclosure.

1. A method of assembling a portable outdoor cooking device, the method comprising:
assembling a plurality of components to form a structural support, the plurality of components comprising a first pipe section, a second pipe section, a third pipe section, and a fourth pipe section;
inserting an anchoring pin into the structural support;
fixing a vertical adjustment assembly to the structural support;
fixing a cooking assembly to the vertical adjustment assembly;
adjusting a vertical position of the cooking assembly; and
swiveling the structural support so that the cooking assembly is positioned over a source of heat.

2. The method of claim 1, further comprising removing disassembled portable grill elements stored in a portable carrying case including at least the first pipe section, the second pipe section, the third pipe section, and the fourth pipe section-of the structural support, the anchoring pin, the cooking assembly, and the vertical adjustment assembly.

3. The method of claim 1, further comprising assembling the vertical adjustment assembly, wherein the vertical adjustment assembly includes at least a handle, a cable, and an adjustment collar.

4. The method of claim 1, further comprising rotating the cooking assembly about an axis.

5. A method of using a portable outdoor cooking device, the method comprising:
removing disassembled portable grill elements stored in a portable carrying case including at least a first pipe section, a second pipe section, a third pipe section, and a fourth pipe section-of a structural support, an anchoring pin, a cooking assembly, and a vertical adjustment assembly;
assembling the portable grill elements to form a hook-shaped structural support comprising the first pipe section, the second pipe section, the third pipe section, and the fourth pipe section;
inserting the anchoring pin into the structural support;
assembling the vertical adjustment assembly, wherein the vertical adjustment assembly includes at least a handle, a cable, and an adjustment collar
fixing the vertical adjustment assembly to the structural support;
fixing the cooking assembly to the vertical adjustment assembly;
adjusting a vertical position of the cooking assembly;
swiveling the structural support so that the cooking assembly is positioned over a source of heat; and
rotating the cooking assembly about an axis.

6. A method of using a portable outdoor cooking device, the method comprising:
retrieving a carrying case storing a plurality of disassembled grill elements of the portable outdoor cooking device, the carrying case including a plurality of fitted storage sections for one or more of the plurality of disassembled grill elements;
removing the plurality of disassembled grill elements stored in the carrying case including at least a first pipe section, a second pipe section, a third pipe section, and a fourth pipe section of a structural support, an anchoring pin, a cooking surface assembly that includes a cooking surface, a plurality of grating support cables, a concave heat plate, and a rotary motor, and a vertical adjustment assembly that includes at least a handle, a cable, and an adjustment collar, the carrying case including a base, a lid, a locking mechanism, and a plurality of hinges, the lid pivoting about the plurality of hinges relative to the base between an open position and a closed position, and the locking mechanism locking the lid in the closed position, and wherein the carrying case includes internal portions positioned within the base and the lid that define separate storage spaces for the structural support, the anchoring pin, the cooking surface assembly, and the vertical adjustment assembly, including a unit assembly formed by the cooking surface, the plurality of grating support cables, and the heat plate that are fitted together and stored in the lid, wherein a plurality of prong members are arranged on the cooking surface assembly or the carrying case to secure the unit assembly in place;
assembling a plurality of components to form the structural support, the plurality of components comprising the first pipe section, the second pipe section, the third pipe section, and the fourth pipe section, wherein each of the plurality of components is coupled to a respective component via a slip/sleeve mechanism, wherein the first pipe section and the second pipe section form a generally hook-shaped portion of the structural support, and the third pipe section and the fourth pipe section form a generally longitudinal portion of the structural support, and wherein the second pipe section defines a plurality of telescope apertures along a longitudinal length of the second pipe section to allow the second pipe section to be coupled to the first pipe section at a plurality of different locations corresponding to the telescope apertures so that a length that the first pipe section extends horizontally from the third pipe section and the fourth pipe section is varied;
inserting a first portion of the anchoring pin into the fourth pipe section;
assembling components of the vertical adjustment assembly, wherein the vertical adjustment assembly allows for a spatial position of the cooking surface assembly to be vertically modified;
fixing the vertical adjustment assembly to the structural support;
assembling components of the cooking assembly including unfolding the cooking surface about a hinged portion so that a first portion of the cooking surface is generally planar with respect to a second portion of the cooking surface and positioning the heat plate defining concave space into which at least a portion of the cooking assembly is positioned;
fixing the cooking assembly to the vertical adjustment assembly to form an assembled portable outdoor cooking device;
inserting a second portion of the anchoring pin into a ground surface to secure the assembled portable outdoor cooking device to the ground surface;
adjusting a vertical position of the cooking assembly;
swiveling the structural support so that the cooking assembly is positioned over a source of heat; and
starting the rotary motor to rotate the cooking assembly about an axis.
